(19) United States
(12) Patent Application Publication
(10) Pub. No.: US 2025/0122383 A1
(43) Pub. Date: Apr. 17, 2025

(54) COLORING WITH HIGH EFFECTIVE SOLAR REFLECTANCE

(71) Applicant: Meta Platforms Technologies, LLC, Menlo Park, CA (US)

(72) Inventors: Lindsey Gilman, Stockton, MO (US); Jing Chen, Bellevue, WA (US); Renate Eva Klementine Landig, Kirkland, WA (US); Christopher Yuan Ting Liao, Seattle, WA (US); Ruiqing Ma, Kirkland, WA (US); Andrew John Ouderkirk, Kirkland, WA (US)

(21) Appl. No.: 18/776,684

(22) Filed: Jul. 18, 2024

Related U.S. Application Data
(60) Provisional application No. 63/590,611, filed on Oct. 16, 2023.

(51) Int. Cl. C09D 5/33; C09D 5/22; G02B 5/20; G02B 5/26

(52) U.S. Cl. CPC C09D 5/004; C09D 5/22; G02B 5/208; G02B 5/26

(57) ABSTRACT

A solar reflective coating includes a reflective layer and a black layer overlying the reflective layer, where the black layer includes active particles dispersed throughout a matrix. Example active particles include phosphor microcrystals adapted to reflect incident non-visible radiation and convert incident visible radiation to non-visible radiation.

### CROSS-REFERENCE TO RELATED APPLICATION

This application claims the benefit of priority under 35 U.S.C. § 119 (e) of U.S. Provisional Application No. 63/590,611, filed Oct. 16, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a schematic diagram illustrating the principle of operation of a black-colored solar reflective coating according to some embodiments.

FIG. 2 is a schematic illustration of example solar reflective coating integration architectures according to some embodiments.

FIG. 3 is a cross-sectional view of an exemplary solar reflective coating according to various embodiments.

FIG. 4 is a cross-sectional view of an exemplary multi-layer solar reflective coating according to various embodiments.

FIG. 5 is a cross-sectional view of an exemplary patterned solar reflective coating according to various embodiments.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure relates to a solar reflective coating, a substrate or workpiece having a surface treated with the solar reflective coating, and components such as an augmented reality headset having solar reflective properties.

Virtual reality (VR) and augmented reality (AR) eyewear devices or headsets may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/AR eyewear devices and headsets may be used for a variety of purposes. For example, governments may use such devices for military training, medical professionals may use such devices to simulate surgery, and engineers may use such devices as design visualization aids.

During outdoor use, virtual reality (VR) and augmented reality (AR) eyewear devices or headsets may be exposed to ambient light, including direct sunlight. Particularly in the case of devices or headsets that are colored black per industry standards, substantial absorption of the solar spectrum (e.g., UV, visible, and IR radiation) may lead to significant and undesired heating of the device that may create user discomfort.

Notwithstanding recent developments, it would be advantageous to provide an efficient and cost-effective thermal management solution for virtual reality and augmented reality eyewear devices or headsets that inhibits unwanted solar heating while providing for a wide range of color selection options, including black.

In accordance with various embodiments, a solar reflective coating may be applied to an interior or an exterior (i.e., world-facing) surface of a workpiece such as an augmented reality headset. The coating may be applied to the frame of a pair of AR eyeglasses, for example. The solar reflective coating may include an additive such as one or more of a class of photon down-conversion or up-conversion materials or structures, such as phosphor microcrystals dispersed throughout a suitable matrix. Alternatively, a solar reflective coating may include a layer (e.g., monolayer) of phosphor microcrystals not embedded within a matrix. The down-conversion or up-conversion materials may be configured to absorb incident light within the visible spectrum and emit visible and/or non-visible light (e.g., UV and/or IR radiation). Further example down-conversion or up-conversion materials/structures include fluorophores, quantum dots, carbon dots, fluorescent dyes, organic rare-earth complexes, inorganic rare-earth complexes, etc.

A reflective component may include a reflective layer or particles of a reflective medium and may be located proximate to the down-conversion or up-conversion material. In some embodiments, a reflective component may constitute voids that are distributed throughout a matrix material. A reflective layer may include a single layer or a multilayer architecture. A reflective layer may include a single or multilayer metal film, for example, such a silver or silver coated over one or both sides of a dielectric, semiconducting, or different metal layer. In lieu of silver, other suitable metals include aluminum, copper, and gold. Within a reflective multilayer, the individual layers may have equivalent or non-equivalent composition, structure, thickness, etc.

In accordance with various embodiments, reference may be made herein to solar reflective coatings and related structures that include phosphor microcrystals. It will be understood that such coatings and structures, in addition or in lieu of phosphor microcrystals, may include additional or alternative down-conversion or up-conversion materials as disclosed herein.

Example solar reflective coatings may be configured to absorb visible wavelengths and reflect or emit visible and/or non-visible wavelengths. In some embodiments, UV radiation incident upon a solar reflective coating may be reflected and visible radiation incident upon the solar reflective coating may be converted to IR radiation that is emitted. In further embodiments, UV, near-IR, and/or short wavelength IR radiation incident upon a solar reflective coating may be reflected and visible radiation incident upon the solar reflective coating may be converted to visible and/or IR radiation that is emitted. Further example solar reflective coatings may be configured to emit and/or reflect selected bands of the visible spectrum. Redirection and/or modulation of incident visible light may inhibit solar heating of the workpiece. For instance, the phosphor microcrystals may be adapted to absorb part of or all wavelengths in the visible spectrum (^{˜}380-700 nm) and emit in one or more non-visible regions (<380 nm or >700 nm).

Example phosphors may be configured to absorb radiation across a selected band of visible wavelengths. In particular embodiments, phosphor microcrystals may be incorporated into a coating in an amount effective to down-convert absorbed visible wavelengths to IR radiation or up-convert absorbed visible wavelengths to UV radiation. In an idealized example of 100% quantum efficiency, all visible light may be absorbed by the coating, which may lead to an effective solar reflectivity of approximately 85%, and the emission of down-converted photons may be at approximately 800 nm, such that the visible solar spectrum absorbed as heat is decreased by approximately 65% compared to a black layer that only absorbs in the visible range. By way of example, a phosphor microcrystal material may efficiently down-convert blue and red light while reflecting green light.

In some embodiments, blue light may be converted by fluorescence to a wavelength greater than approximately 400 nm, which may include infrared, red, or green wavelengths. In further embodiments, blue and green light may be converted by fluorescence to a wavelength greater than approximately 400 nm, which may include infrared or red wavelengths. In particular embodiments, the impact of solar loading on the temperature of a workpiece may be decreased by converting visible light incident on the workpiece to non-visible wavelengths.

According to some embodiments, a solar reflective coating includes one or more additives distributed throughout a matrix. Such a solar reflective coating may be adapted to convert (e.g., down-convert) visible radiation incident upon the coating into infrared radiation. According to some embodiments, a solar reflective coating may be adapted to convert (e.g., up-convert) visible radiation incident upon the coating into ultra-violet radiation. According to further embodiments, a solar reflective coating may be adapted to convert visible radiation incident upon the coating into infrared radiation and ultra-violet radiation.

The presently-disclosed solar reflective coatings may be adapted to reflect infrared radiation and/or ultra-violet radiation, including infrared and ultra-violet radiation incident upon the coating, infrared radiation produced by the down-conversion of visible radiation, and ultra-violet radiation produced by the up-conversion of visible radiation.

Applicants have shown that in contrast to a comparative black substrate or coating that absorbs only in the visible spectrum and that has a maximum solar reflectance of approximately 55%, phosphor-containing black layers as disclosed herein may exhibit an effective solar reflectance of up to approximately 85%.

A solar reflective coating may include a black layer having phosphor microcrystals dispersed throughout a matrix material. In some examples, the black layer may be configured to absorb visible radiation and reflect both UV and near-IR radiation. In some examples, the black layer may be configured to absorb visible radiation and transmit both UV and near-IR radiation. A black layer may be characterized by a total effective solar reflectivity of at least approximately 10%, e.g., 10, 20, 50, 80, 90, 95, or 100%, including ranges between any of the foregoing values. As used herein, a “black layer” may absorb all or substantially all incident electromagnetic radiation.

In some embodiments, a black layer may be configured as a single layer or as a multi-layer where each individual layer includes one or more phosphor microcrystals. Each respective layer in a multi-layer may include phosphor microcrystals dispersed throughout a matrix or phosphor microcrystals not dispersed throughout a matrix. In some embodiments, a black layer may be configured to reflect incident light.

An additive, such as microcrystals of a phosphor, may be characterized by a particle size of at least approximately 1 nm, e.g., 1, 2, 5, 10, 20, 50, 100, 200, 500, 1000, 2000, 5000, 10000, 20000, 50000, 100000, 200000, 500000, or 1000000 nm, including ranges between any of the foregoing values, and may have a quantum yield of at least approximately 10%, e.g., 10, 20, 50, 80, 90, or 100%, including ranges between any of the foregoing values.

Phosphor microcrystals may be tuned to absorb across the visible spectrum and down-convert incident photons to a wavelength of approximately 800 nm. The phosphor microcrystals may be dispersed throughout a matrix material at a loading fraction effective to absorb up to approximately 50 to 100% of incident visible light. In some instantiations, a loading fraction of phosphor microcrystals in a polymer matrix may range from approximately 0.1 wt. % to 50 wt. %, e.g., 0.1, 0.2, 0.5, 1, 2, 5, 10, 20, or 50 wt. %, including ranges between any of the foregoing values.

In addition to phosphor microcrystals, a black layer may include an organic or an inorganic additive, such as a binder or particles of a pigment. Example binders include polymers such as acrylates, acrylics, epoxies, phenolics, urethanes, polyesters, polyolefins, and polycarbonates. An additive, such as phosphor microcrystals or pigment particles, may be individually coated with a protective coating. In some embodiments, a solar reflective coating may appear black in color and may be protected from humidity and/or oxidation by an over-formed environment-facing coating. A protective coating may include silicon dioxide, for example, and may have a thickness of less than approximately 50 nm, e.g., 10, 20, 30, or 40 nm, including ranges between any of the foregoing values.

In addition to, or in lieu of, the addition of a pigment to control color, a non-pigment approach may include the inclusion of a structured color layer. As used herein, a structured color layer may include geometric features, such as micro- or nano-structured features that are configured to interact with incident light to modify an emitted wavelength. A structured color layer may include an engineered nano-surface or meta surface, for example.

A solar reflective coating containing down-conversion phosphor microcrystals may be protected from excessive UV radiation exposure by a UV blocking layer. For instance, a UV blocking layer may protect dyes or pigments incorporated into the solar reflective coating from degradation. A solar reflective coating containing up-conversion phosphor microcrystals may be protected from excessive IR radiation exposure by an IR blocking layer.

Example phosphors include particles of yttrium aluminum oxide, which may be homogeneously or non-homogeneously dispersed throughout a matrix. Further example phosphors include doped silicate garnets, Mn²⁺-doped MgAl₂O₄, double perovskite Cs₂AgInCl₆: Cr³⁺, non-rare earth Na₃AlF₆: Cr³⁺, Cr³⁺-activated silicate phosphors, and the like. Example matrix materials include organic (e.g., polymer) and inorganic (e.g., glass) materials. Additional additives capable of interacting with incident light include fluorophores, carbon dots, quantum wells, and quantum dots (e.g., CdSe, PbSe, InAs, PbS, etc., and optionally having an outer shell of ZnS or CdS to reduce toxicity). The matrix may be selected to minimize quenching of phosphor microcrystals.

According to still further embodiments, a solar reflective coating may include particles or a layer of a photovoltaic material, which may be configured to convert incident radiation into electrical energy. By way of example, a photovoltaic layer may include p-n organic or inorganic photovoltaic devices configured to convert at least a portion of UV, visible, or infrared light into electrical power that may be used, for example, by an associated electrical device.

Methods for forming a black layer, e.g., over a substrate or workpiece, include spray coating, powder coating, dip-coating, lamination (e.g., in-mold lamination), compression, over-molding, and injection molding. A black layer thickness may be at least approximately 1 micrometer, e.g., 1, 2, 5, 10, 20, 50, 100, 200, 500, or 1000 micrometers, including ranges between any of the foregoing values.

In some examples, the black layer may overlie and be co-integrated with a reflective layer. A reflective layer, if provided, may have a total solar reflectivity of at least approximately 40%. A reflective layer may include a reflective filler. Example reflective fillers include inorganic particles, e.g., metal particles, which may have any suitable shape, e.g., sphere, rod, flake, or fiber. Reflective fillers may be colored, white, translucent, or transparent.

A reflective layer may be non-porous or porous. Pores may be monodisperse or polydisperse and may have a pore size ranging from approximately 1 nm to 10 micrometers. A reflective layer may be formed by coating a mixture of a binder and a reflective filler. Example binders include polymers such as acrylates, acrylics, epoxies, phenolics, urethanes, polyesters, polyolefins, and polycarbonates. Example methods for forming a reflective layer, e.g., over a substrate or a workpiece, include spray coating, powder coating, dip coating, lamination, compression, over-molding, and injection molding. Radiation that is emitted by the phosphor microcrystals may be reflected back into the environment by the reflective layer.

In lieu of, or in addition to, forming a solar reflective coating over a workpiece, one or more coating components may be embedded into the workpiece itself. By way of example, one or more of phosphor microcrystals and particles of a reflective medium may be incorporated into the frame of a pair of AR glasses, e.g., during manufacture of the frame via extrusion or injection molding. In further embodiments, one or more coating components of a solar reflective coating may be mixed with a dye and applied to textiles or clothing.

As will be appreciated, the solar reflective materials and coatings disclosed herein may be incorporated into a variety of applications and products. In addition to consumer electronics, such as portable or wearable devices (e.g., smart phones, smart watches, fitness devices, AR/VR devices and headsets, etc.) solar reflective coatings may be used in architectural and transportation industries, for example. Applications include window and wall coatings, and roofing materials, automotive glazings, clothing including fire gear and other personal protective equipment, upholstery, car seats and strollers, bicycle seats, and other high solar exposure items.

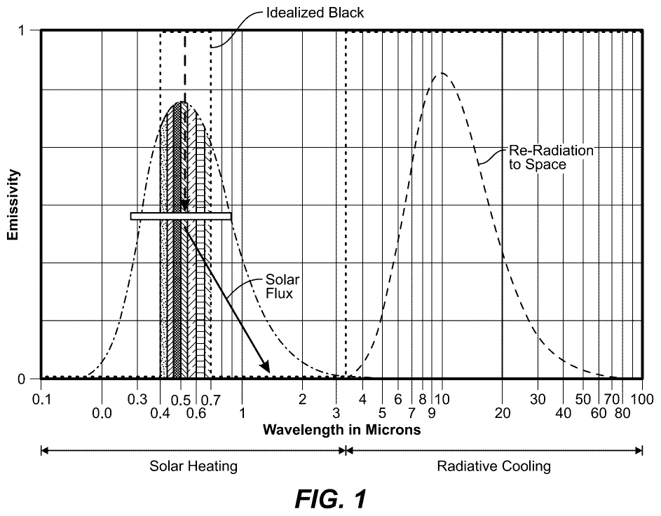

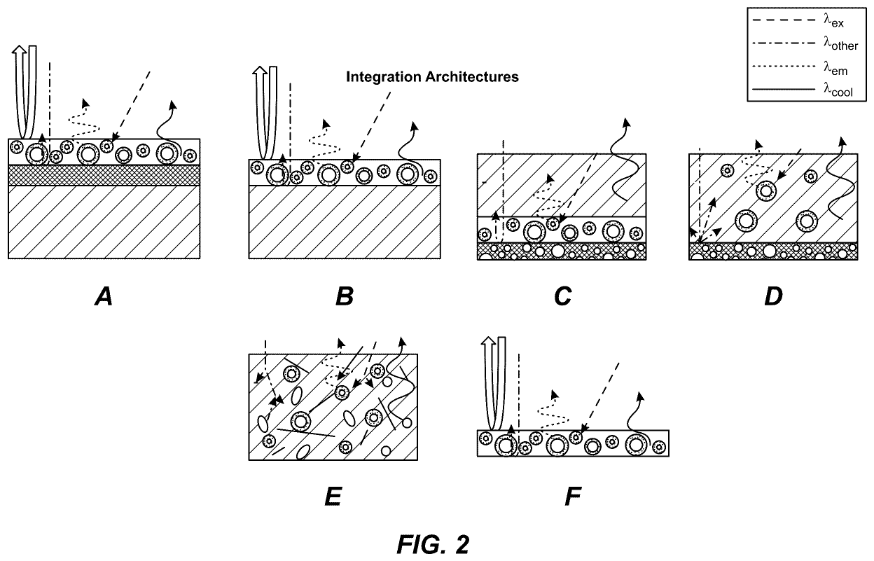

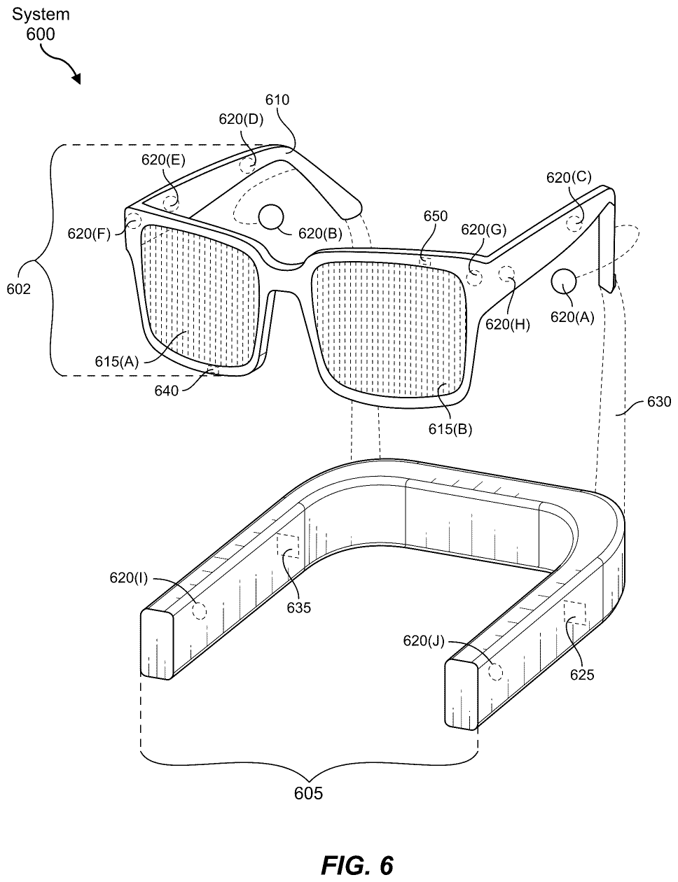

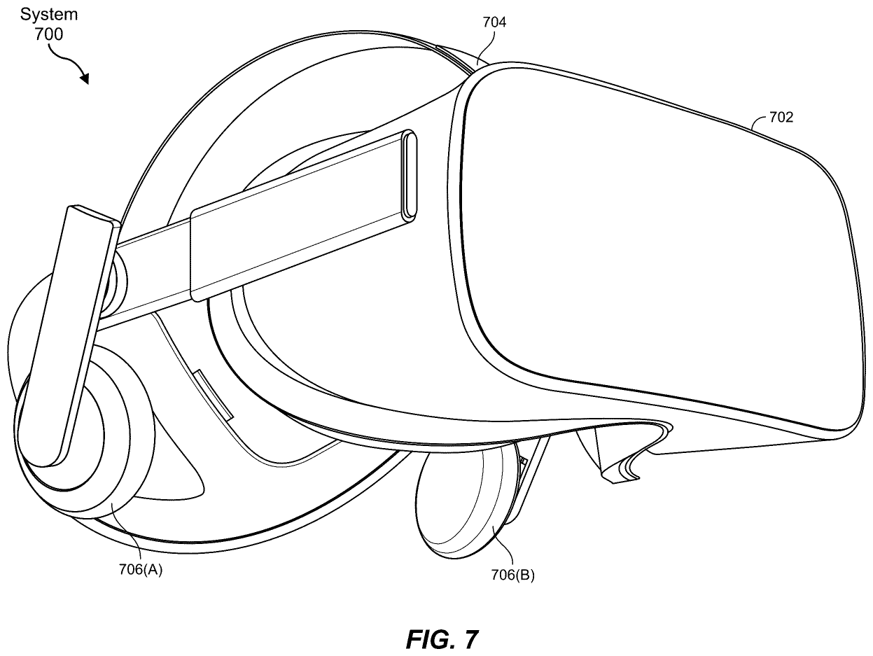

The following will provide, with reference to FIGS. 1-7, detailed descriptions of solar reflective coatings and apparatus provided with such coatings. The discussion associated with FIG. 1 includes a description of a mechanism of operation of an example solar reflective coating. The discussion associated with FIGS. 2-5 includes a description of example solar reflective coatings. The discussion associated with FIGS. 6 and 7 relates to exemplary virtual reality and augmented reality devices that may include one or more solar reflective coatings as disclosed herein.

Referring to FIG. 1, shown is a schematic diagram illustrating a mechanism of operation of an exemplary solar reflective coating. The solar reflective coating may be configured to down-convert incident visible light to infrared (IR) radiation and, in addition to reflecting solar energy in the UV and near-IR bands, reradiate the down-converted IR radiation to control thermal heating of an article having an over-formed solar reflective coating. Such a solar reflective coating may have a LWIR emissivity effective to cause a coated article to emit thermal radiation.

Various solar reflective architectures are illustrated in FIG. 2. Referring to FIG. 2A, a solar reflective coating includes a reflective layer disposed over an exterior surface of a workpiece and a black layer (i.e., down-or up-conversion layer) disposed over the reflective layer. The black layer includes active particles (e.g., phosphor microcrystals) dispersed throughout a matrix.

Referring to FIG. 2B, a solar reflective coating includes a black layer disposed directly over the exterior surface of a workpiece. The black layer may be configured to both down-convert selected wavelengths and reflect non-selected wavelengths.

Referring to FIG. 2C, a solar reflective coating is disposed over an interior surface of a workpiece. The solar reflective coating of FIG. 2C includes a black layer disposed over the workpiece and a reflective layer disposed over the black layer. The reflective layer may include reflective particles dispersed throughout a suitable matrix.

A hybrid architecture is illustrated in FIG. 2D. In FIG. 2D, a reflective layer is disposed over an interior surface of a workpiece and phosphor microcrystals are distributed throughout the workpiece itself. Referring to FIG. 2E, both phosphor microcrystals and scattering particles may be distributed throughout a workpiece. Referring to FIG. 2F, active particles of a down-or up-conversion material may be dispersed throughout a workpiece.

Shown schematically in FIGS. 2A-2F are incident photons (λₑₓ) that are absorbed by the active material (i.e., phosphor microcrystals) as well as other (λₒₜₕₑᵣ) forms of incident radiation (e.g., UV and IR radiation) incident upon the solar reflective coating. Also shown are the emission of down-converted IR photons (λₑₘ) and long wavelength IR (LWIR) radiation (λ_{cool}) (i.e., blackbody emission).

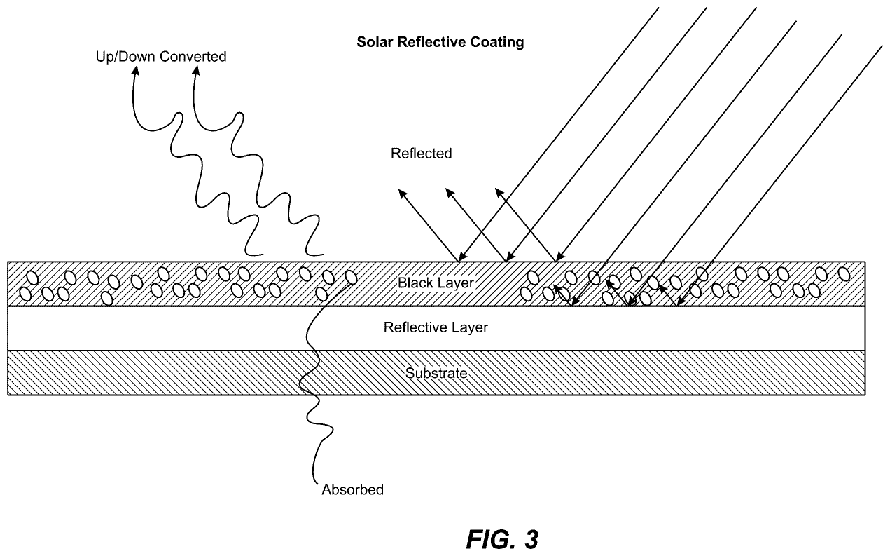

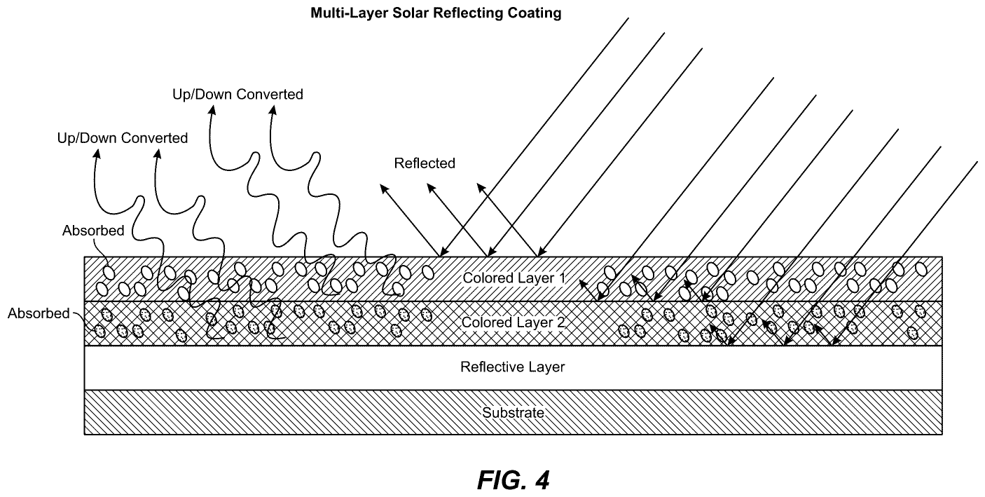

A solar reflective coating including a black layer and a reflective layer overlying a substrate is shown in FIG. 3. The substrate may include the frame of a pair of AR glasses. The black layer includes phosphor microcrystals embedded throughout an organic or inorganic matrix. The black layer may be a uniform, continuous single layer, as shown in FIG. 3, or a may have a multi-layer architecture, as shown in FIG. 4. The individual layers within a multi-layer solar reflective coating may be configured to absorb or reflect incident radiation within a specified band. For example, a first layer may include first phosphor microcrystals adapted to down-convert red light to IR radiation and a second layer may include second phosphor microcrystals adapted to down-convert green and blue light to IR radiation. In both single layer and multilayer approaches, a solar reflective coating may be configured to impart any chosen color by selectively reflecting specified wavelengths and/or emitting absorbed photons with a chosen region of the visible spectrum. Thus, in some embodiments, active particles may be configured to tune a perceived color of a solar reflective coating.

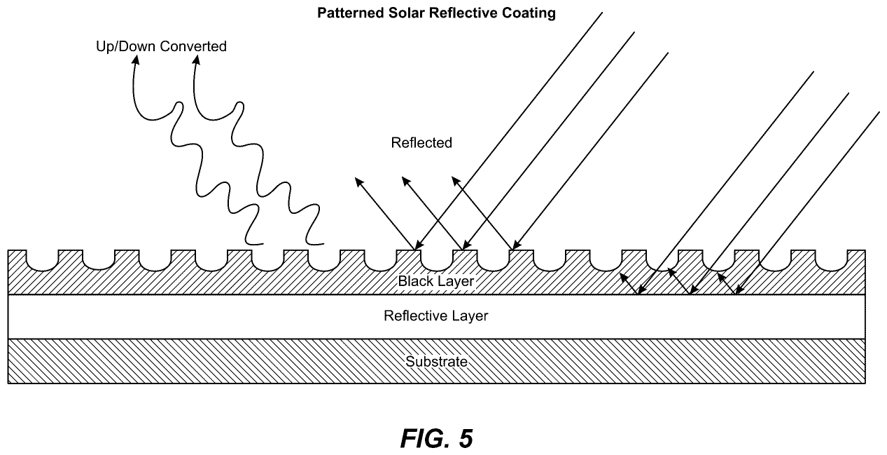

According to still further embodiments, as depicted in FIG. 5, the black layer may be patterned. In certain instantiations, patterning of a solar reflective coating may be used to impact the directionality of photon absorption and/or emission. A patterned solar reflective coating may be formed in situ during deposition (e.g., using 3D printing) or after layer formation using photolithography and etch techniques. Patterned regions of a solar reflective coating may have nanoscale dimensions. In particular embodiments, the matrix of a solar reflective coating may be configured to include first regions of a first thickness and second regions of a second thickness.

A solar reflective coating having a black color includes an additive configured to reflect non-visible radiation (e.g., solar near-infrared radiation) and convert incident visible radiation to non-visible radiation, which can be reflected. The solar reflective coating may be applied to an article to color the article while inhibiting solar heating of the article. Example additives may include phosphor microcrystals. In addition to an additive-containing black layer, the solar reflective coating may include a reflective layer that is adapted to reflect one or more wavelengths of light.

### EXAMPLE EMBODIMENTS

Example 1: A solar reflective coating includes a reflective component and a black layer overlying the reflective component, where the black layer includes active particles dispersed throughout a matrix.

Example 2: The solar reflective coating of Example 1, where the reflective component includes a plurality of reflective particles or voids.

Example 3: The solar reflective coating of any of Examples 1 and 2, where the reflective component includes a multilayer polymer thin film or a multilayer dielectric thin film.

Example 4: The solar reflective coating of any of Examples 1-3, where the active particles include a material selected from fluorophores, phosphors, fluorescent dyes, organic rare-earth complexes, inorganic rare-earth complexes, and nanoscale particles or nanocrystals of a semiconducting material.

Example 5: The solar reflective coating of any of Examples 1-4, where the active particles are configured to convert incident visible radiation to non-visible radiation.

Example 6: The solar reflective coating of any of Examples 1-5, where the active particles are configured to convert incident visible radiation to visible radiation and non-visible radiation.

Example 7: The solar reflective coating of any of Examples 1-6, where the active particles are configured to tune a perceived color of the solar reflective coating.

Example 8: The solar reflective coating of any of Examples 1-7, where the black layer includes first regions having a first thickness and second regions having a second thickness.

Example 9: The solar reflective coating of any of Examples 1-8, where the black layer is a multilayer including a plurality of stacked layer.

Example 10: The solar reflective coating of any of Examples 1-9, further including a second black layer including second active particles overlying the black layer.

Example 11: The solar reflective coating of Example 10, where the black layer is configured to convert a first band of incident visible radiation to radiation having a first converted wavelength, and the second black layer is configured to convert a second band of the incident visible radiation to radiation having a second converted wavelength.

Example 12: The solar reflective coating of Example 10, where the black layer is configured to convert incident visible radiation to visible radiation having a different wavelength than the incident visible radiation, and the second black layer is configured to convert the visible radiation having the different wavelength to visible radiation or non-visible radiation.

Example 13: An article includes a body, a photon conversion material embedded within the body, and a reflective element embedded within with the body or disposed over a surface of the body, where the photon conversion material is configured to convert visible radiation incident on the body to non-visible radiation.

Example 14: The article of Example 13, where the reflective element includes a plurality of particles or voids embedded within the body.

Example 15: The article of any of Examples 13 and 14, where the reflective element includes a reflective layer overlying the body.

Example 16: The article of any of Examples 13-15, where the photon conversion material is configured to convert visible radiation incident on the body to visible radiation having a different wavelength than the incident visible radiation.

Example 17: The article of any of Examples 13-16, where the reflective element is disposed over a world-facing surface of the body.

Example 18: A solar reflective coating includes a black layer overlying a substrate, where the black layer includes at least one layer of phosphor microcrystals.

Example 19: The solar reflective coating of Example 18, where the at least one layer of phosphor microcrystals includes a monolayer.

Example 20: The solar reflective coating of any of Examples 18 and 19, where the phosphor microcrystals are configured to convert visible radiation to non-visible radiation.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 600 in FIG. 6) or that visually immerses a user in an artificial reality (e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

Augmented-reality system 600 may also include a microphone array with a plurality of acoustic transducers 620(A)-620(J), referred to collectively as acoustic transducers 620. Acoustic transducers 620 may be transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(I) and 620(J), which may be positioned on a corresponding neckband 605.

In some embodiments, one or more of acoustic transducers 620(A)-(F) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented reality device 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a Bluetooth connection). In still other embodiments, acoustic transducers 620(A) and 620(B) may not be used at all in conjunction with augmented-reality system 600.

Acoustic transducers 620 on frame 610 may be positioned along the length of the temples, across the bridge, above or below display devices 615(A) and 615(B), or some combination thereof. Acoustic transducers 620 may be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(I) and 620(J)) that are part of the microphone array (or potentially form their own microphone subarray). Neckband 605 may also include a controller 625 and a power source 635.

Acoustic transducers 620(I) and 620(J) of neckband 605 may be configured to detect sound and convert the detected sound into an electronic format (analog or digital). In the embodiment of FIG. 6, acoustic transducers 620(I) and 620(J) may be positioned on neckband 605, thereby increasing the distance between the neckband acoustic transducers 620(I) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 600 and/or virtual-reality system 700 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 7, output audio transducers 706(A) and 706(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 6, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to active particles that comprise or include phosphor microcrystals include embodiments where active particles consist essentially of phosphor microcrystals and embodiments where active particles consist of phosphor microcrystals.

What is claimed is:

1. A solar reflective coating comprising:
a reflective component; and
a black layer overlying the reflective component, wherein the black layer comprises active particles dispersed throughout a matrix.

2. The solar reflective coating of claim 1, wherein the reflective component comprises a plurality of reflective particles or voids.

3. The solar reflective coating of claim 1, wherein the reflective component comprises a multilayer polymer thin film or a multilayer dielectric thin film.

4. The solar reflective coating of claim 1, wherein the active particles comprise a material selected from the group consisting of fluorophores, phosphors, fluorescent dyes, organic rare-earth complexes, inorganic rare-earth complexes, and nanoscale particles or nanocrystals of a semiconducting material.

5. The solar reflective coating of claim 1, wherein the active particles are configured to convert incident visible radiation to non-visible radiation.

6. The solar reflective coating of claim 1, wherein the active particles are configured to convert incident visible radiation to visible radiation and non-visible radiation.

7. The solar reflective coating of claim 1, wherein the active particles are configured to tune a perceived color of the solar reflective coating.

8. The solar reflective coating of claim 1, wherein the black layer includes first regions having a first thickness and second regions having a second thickness.

9. The solar reflective coating of claim 1, wherein the black layer is a multilayer comprising a plurality of stacked layer.

10. The solar reflective coating of claim 1, further comprising a second black layer including second active particles overlying the black layer.

11. The solar reflective coating of claim 10, wherein the black layer is configured to convert a first band of incident visible radiation to radiation having a first converted wavelength, and the second black layer is configured to convert a second band of the incident visible radiation to radiation having a second converted wavelength.

12. The solar reflective coating of claim 10, wherein the black layer is configured to convert incident visible radiation to visible radiation having a different wavelength than the incident visible radiation, and the second black layer is configured to convert the visible radiation having the different wavelength to visible radiation or non-visible radiation.

13. An article comprising:
a body;
a photon conversion material embedded within the body; and
a reflective element embedded within with the body or disposed over a surface of the body, wherein the photon conversion material is configured to convert visible radiation incident on the body to non-visible radiation.

14. The article of claim 13, wherein the reflective element comprises a plurality of particles or voids embedded within the body.

15. The article of claim 13, wherein the reflective element comprises a reflective layer overlying the body.

16. The article of claim 13, wherein the photon conversion material is configured to convert visible radiation incident on the body to visible radiation having a different wavelength than the incident visible radiation.

17. The article of claim 13, wherein the reflective element is disposed over a world-facing surface of the body.

18. A solar reflective coating comprising:
a black layer overlying a substrate, wherein the black layer comprises at least one layer of phosphor microcrystals.

19. The solar reflective coating of claim 18, wherein the at least one layer of phosphor microcrystals comprises a monolayer.

20. The solar reflective coating of claim 18, wherein the phosphor microcrystals are configured to convert visible radiation to non-visible radiation.
